(19) United States
(12) Patent Application Publication
(10) Pub. No.: US 2022/0126538 A1
(43) Pub. Date: Apr. 28, 2022

(54) INJECTION MOLDING METHOD

(71) Applicants: Cheng-Ho Chen, Changhua County (TW); Chih-Tsung Kuo, Taichung City (TW)

(72) Inventors: Chih-Tsung Kuo, Taichung City (TW); Chuen-Cherng Yang, Taichung City (TW)

(73) Assignees: Cheng-Ho Chen; Chih-Tsung Kuo

(21) Appl. No.: 17/509,030

(22) Filed: Oct. 24, 2021

(30) Foreign Application Priority Data
Oct. 26, 2020 (TW) 109137135

(51) Int. Cl. B29D 11/00; C03B 19/02

(52) U.S. Cl. CPC B29D 11/00009; C03B 19/025

(57) ABSTRACT

An injection molding method includes the steps of:(A) preparing a molding unit and an injection unit, the molding unit including a first mold having a protruding portion, and a second mold having a movable post cooperating with an inner peripheral surface thereof to define a cavity; (B) moving the molds toward each other until the protruding portion cooperates with the second mold to define a forming space; (C) activating the injection unit for injecting the molten optical material into the forming space; (D) cooling the molding unit; and (E) moving the molds away from each other and subsequently activating the movable post to push a solidified optical material out of the forming space.

### CROSS-REFERENCE TO RELATED APPLICATION

This application claims priority of Taiwanese Patent Application No. 109137135, filed on Oct. 26, 2020.

### FIELD

The disclosure relates to an injection molding method for making an optical lens.

### BACKGROUND

Generally, an optical lens may be made by processes, such as grinding, hot pressing and injection molding. The injection molding may be divided into a horizontal molding and a vertical molding according to an injection direction of a material barrel. Referring to FIGS. 1 and 2, when using the injection molding process, a molten optical material is usually injected along a direction perpendicular to abutment surfaces 81 of two molds 83. According to the foregoing process classification and structural configuration, it can be understood that in the horizontal molding process, a runner 82 extends along a horizontal direction (D1), and the molds 83 move along the horizontal direction (D1) to mate with each other (see FIG. 1). Since the optical lens 84 has a curved structure and is upright, flow of raw material during injection is easily affected by gravity, resulting in a higher density on a lower side of the optical lens 84, which in turn makes the overall density of the optical lens 84 uneven, thereby affecting the optical properties (such as refractive index) thereof. In the vertical molding process, the runner 82 extends along a vertical direction (D2), and the molds 83 move along the vertical direction (D2) to mate with each other (see FIG. 2). In this way, the optical lens 84 lies flat during injection of the raw material and is less susceptible to gravity.

Regardless of whether it is horizontal or vertical molding process, the problem of overflow of the molten optical material from the abutment surfaces 81 of the molds 83 must be considered. In order to fill the entire mold cavity with the molten optical material, the pressure in the mold cavity must reach a certain value and a pressure maintaining state. In the pressure maintaining state, the direction of the maintaining pressure is the same as mold closing direction, causing the molten optical material in the mold cavity to easily overflow from the abutment surfaces 81 and cause burrs, so that additional processing is required, causing material waste.

Based on the characteristics of fluid, a runner is designed to have a thickness gradually thinning from one end to the other end, so that, when the fluid is pushed, it can be delivered stably. In addition, to manufacture multiple products at the same time, multiple runners are provided in the mold to divide the flow. To achieve flow diversion, the runner will be further extended and a front section thereof will be enlarged and thickened. A traditional mold assembly 91 is shown in FIG. 3, and includes a thick main runner 911 and multiple sub-runners 912 diverging from the main runner 911. The main runner 91 and the sub-runners 912 flow in different directions, and will form multiple corners, causing pressure loss. Further, because the viscosity of the optical material in the molten state is high, the runners, which are multiple in number and are long, will produce more pressure loss and cause uneven pressure inside the runners. Excessive pressure loss will cause the machine to bear a relatively high load and to push with difficulty. The uneven pressure inside the runners will result in the inability to form more precise products, leading to material waste. Moreover, a portion of the optical material remaining inside the runners after cooling will become waste and cannot be reused (this is because the material undergoes qualitative change and stress crystallization after the first heating), resulting in waste of material and high production costs. A solid blank 92 obtained after cooling is shown in FIG. 4. The solid blank 92 includes a waste portion 921 and a plurality of finished product portions 922. The waste portion 921 must be removed to obtain the finished products 922 for sale.

### SUMMARY

Therefore, an object of the present disclosure is to provide an injection molding method that can alleviate at least one of the drawbacks of the prior art.

Accordingly, an injection molding method of this disclosure includes the following steps:

(A) preparing a molding unit and an injection unit, the molding unit including a first mold and a second mold movable toward and away from each other along a moving direction, the first mold including a base portion having an abutment surface, and a protruding portion protruding outward from the abutment surface and having an outer peripheral surface, the second mold including a mold body that has an inner peripheral surface, and a movable post that extends into and that is movable relative to the inner peripheral surface along the moving direction and that cooperates with the same to define a cavity, the mold body further having an abutment surface facing the abutment surface of the base portion, and an injection channel that is spaced apart from and extends in a direction parallel to the abutment surface of the second mold and that communicates with the cavity, the injection unit being adjacent to the molding unit and being configured to inject a molten optical material directly into the injection channel;

(B) moving the first and second molds toward each other until the abutment surfaces of the base portion and the second mold abut against each other and until the protruding portion extends into the cavity and cooperates with the second mold to define a forming space in the cavity, the outer peripheral surface of the protruding portion being fitted into the inner peripheral surface of the mold body of the second mold;

(C) activating the injection unit for injecting the molten optical material into the forming space through the injection channel;

(D) cooling the molding unit to solidify the molten optical material in the forming space; and

(E) moving the first and second molds away from each other after the molten optical material has solidified to expose the forming space, and subsequently activating the movable post to push the solidified optical material out of the forming space.

### BRIEF DESCRIPTION OF THE DRAWINGS

Other features and advantages of the disclosure will become apparent in the following detailed description of the embodiment with reference to the accompanying drawings, of which:

FIG. 1 is a schematic view, illustrating relations of components in a horizontal molding process;

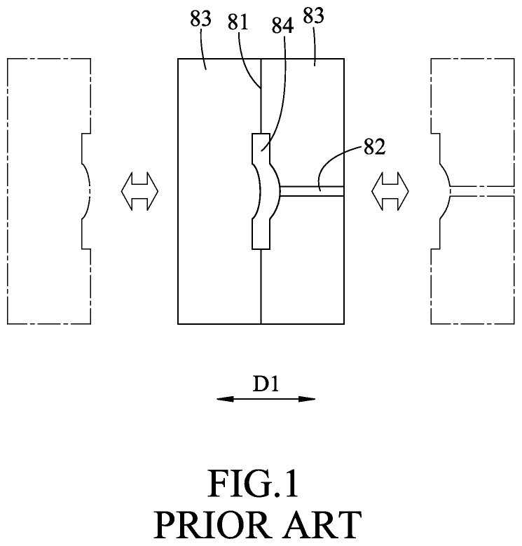

FIG. 2 is a schematic view, illustrating relations of components in a vertical molding process;

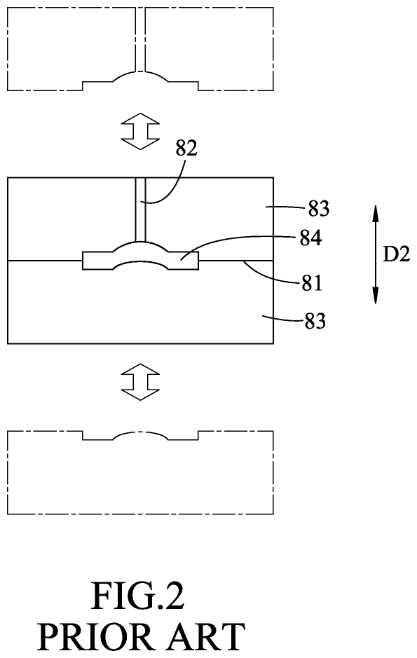

FIG. 3 is a schematic view of a traditional mold assembly;

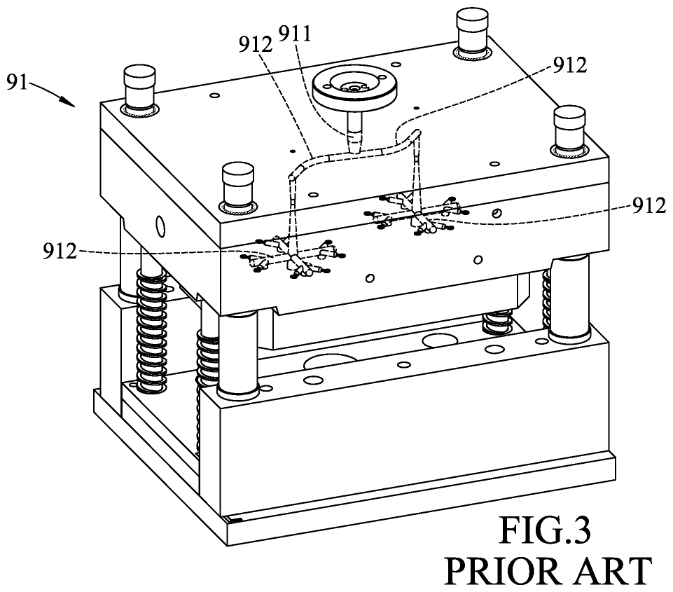

FIG. 4 is a schematic view of a solid blank;

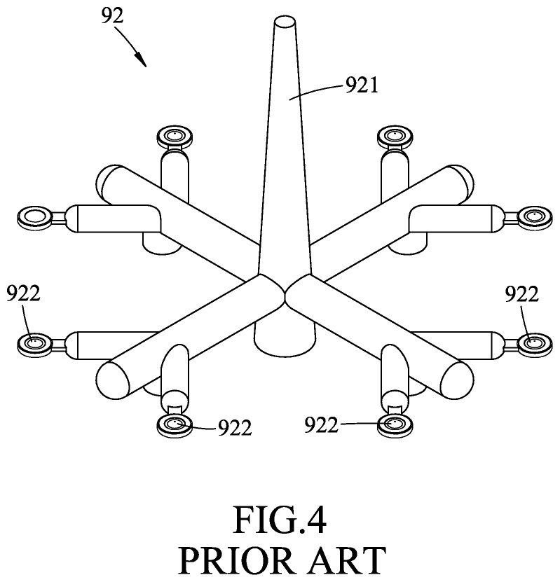

FIG. 5 is a schematic view of a molding unit and an injection unit employed in an injection molding method according to an embodiment of the present disclosure; and

FIG. 6 is a view similar to FIG. 5, but with the molding unit and the injection unit being moved away from each other.

### DETAILED DESCRIPTION

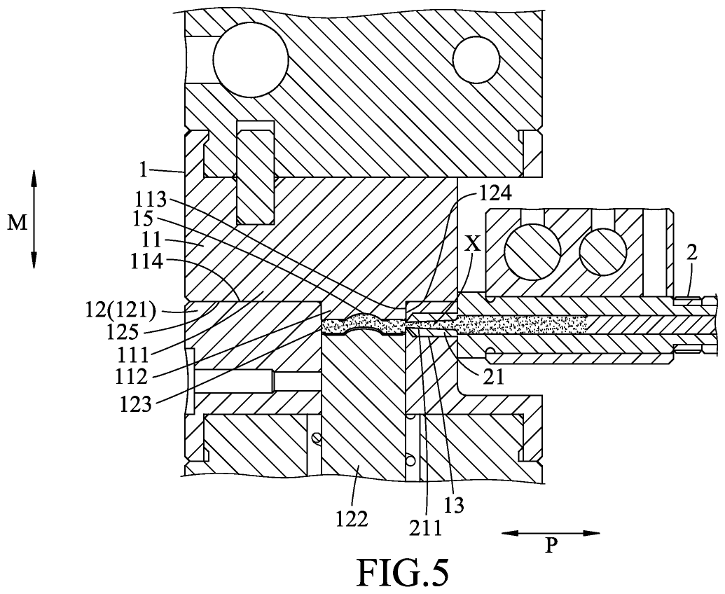

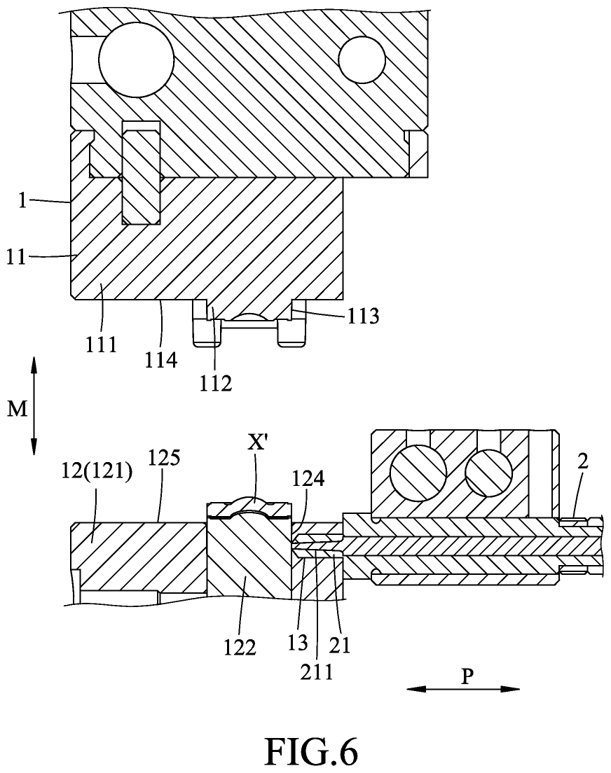

An injection molding method according to an embodiment of the present disclosure includes first to fifth steps, and will be described in detail below with reference to FIGS. 5 and 6.

In the first step, a molding unit 1 and an injection unit 2 are prepared. The molding unit 1 includes a first mold 11 and a second mold 12 movable toward and away from each other along a moving direction (M). In this embodiment, the moving direction (M) is a vertical direction. The first mold 11 includes a base portion 111 having an abutment surface 114, and a protruding portion 112 protruding outward and downward from the abutment surface 114 and having an outer peripheral surface 113. The second mold 12 includes a mold body 121 having an inner peripheral surface 124, and a movable post 122 that extends into and that is movable relative to the inner peripheral surface 124 along the moving direction (M). The inner peripheral surface 124 and the movable post 122 cooperate with each other to define a cavity 123. The mold body 121 further has an abutment surface 125 facing the abutment surface 114 of the base portion 111, and an injection channel 13 that is spaced apart from and extends in a direction parallel to the abutment surface 125 and that communicates with the cavity 123. Each of the abutment surface 114 and the abutment surface 125 extends in a horizontal direction perpendicular to the moving direction (M). Because the moving direction (M) is a vertical direction, and the abutment surfaces 114 and 125 extend in the horizontal direction, the influence of gravity can be reduced.

The injection unit 2 is adjacent to the molding unit 1, and includes a nozzle 21 extending into the injection channel 13 and defining an internal passage 211. The injection unit 2 is configured to inject a molten optical material (X) directly into the injection channel 13 through the nozzle 21. The optical material (X) can be a material suitable for making optical lenses, such as glass or plastic.

In the second step, the first mold 11 and the second mold 12 are moved toward each other until the abutment surfaces 114, 125 thereof abut against each other, and the protruding portion 112 of the first mold 11 extends into the cavity 123 and cooperates with the mold body 121 and the movable post 122 of the second mold 12 to define a forming space 15 in the cavity 123. The forming space 15 communicates with the injection channel 13.

In the third step, the injection unit 2 is activated for injecting the molten optical material (X) into the forming space 15 through the injection channel 13, as shown in FIG. 5.

In the fourth step, the molding unit 1 is cooled to solidify the molten optical material (X) in the forming space 15.

In the fifth step, the first mold 11 and the second mold 12 are moved away from each other after the molten optical material (X) has solidified to expose the forming space 15, and the movable post 122 is subsequently activated to push the solidified optical material (X′) out of the forming space 15, as shown in FIG. 6. The solidified optical material (X′) is now a product that can be sold.

It should be noted herein that, when the first mold 11 and the second mold 12 are mated with each other, the outer peripheral surface 113 of the protruding portion 112 is fitted into the inner peripheral surface 124 of the mold body 121 of the second mold 12, and the forming space 15 is staggered with the abutment surfaces 114, 125 of the first mold 11 and the second mold 12, so that the problem of overflow of the molten optical material (X) from the abutment surfaces 114, 125 is less prone to occur.

Further, since the injection unit 2 directly injects the molten optical material (X) into the injection channel 13 through the nozzle 21, the second mold 12 does not need to have other runners for diversion, and there is almost no waste remaining in the injection channel 13. Moreover, when the nozzle 21 extends into the injection channel 13, the internal passage 211 thereof gradually tapers from the injection channel 13 toward the forming space 15, so that the pressure of the molten optical material (X) will gradually increase as it moves toward the forming space 15, and the molten optical material (X) can be injected into the forming space 15 from the nozzle 21.

Since the forming space 15 is staggered with the abutment surfaces 114, 125 of the first mold 11 and the second mold 12, and since the injection channel 13 is not provided in the abutment surfaces 114, 125, the injection channel 13 can be designed to be relatively short, so that the injection unit 2 has a small load when pushing the molten optical material (X) and can easily push the same. If the injection channel 13 is designed short, the waste remaining in the injection channel 13 can be minimized, so that the production cost can be reduced. Additionally, the injection channel 13 and the internal passage 211 of the nozzle 21 are straight passages without any corners, so that the pressure loss generated by the molten optical material (X) is lesser compared with the prior art, which can further reduce the load required for pushing the molten optical material (X).

Moreover, a pressure-maintaining direction (P) when the injection unit 2 pushes the molten optical material (X) is a direction extending along the injection channel 13. The injection channel 13 extends in a direction parallel to the abutment surfaces 114, 125 of the first mold 11 and the second mold 12, so that the pressure-maintaining direction (P) is perpendicular to the moving direction (M), further reducing the load when the injection unit 2 pushes the molten optical material (X).

In summary, with the protruding portion 112 of the first mold 11 extending into the cavity 123 in the second mold 12 when the abutment surfaces 114, 125 of the first mold 11 and the second mold 12 mate with each other so that the forming space 15 is staggered with the abutment surfaces 114, 125, the problem of overflow of the molten optical material (X) from the abutment surfaces 114, 125 does not easily occur. Further, with the injection unit 2 directly injecting the molten optical material (X) from the injection channel 13 to the forming space 15, the injection channel 13 can be designed to be short so as to reduce the load when pushing the molten optical material (X), so that there is almost no waste. Moreover, because the injection channel 13 extends in a direction parallel to the abutment surfaces 114, 125, the pressure-maintaining direction (P) is different from the moving direction (M), further reducing the load when pushing the molten optical material (X). Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An injection molding method comprising:
(A) preparing a molding unit and an injection unit, the molding unit including a first mold and a second mold movable toward and away from each other along a moving direction, the first mold including a base portion having an abutment surface, and a protruding portion protruding outward from the abutment surface and having an outer peripheral surface, the second mold including a mold body that has an inner peripheral surface, and a movable post that extends into the inner peripheral surface, that is movable relative to the inner peripheral surface along the moving direction, and that cooperates with the inner peripheral surface to define a cavity, the mold body further having an abutment surface facing the abutment surface of the base portion, and an injection channel that is spaced apart from and extends in a direction parallel to the abutment surface of the second mold and that communicates with the cavity, the injection unit being adjacent to the molding unit and being configured to inject a molten optical material directly into the injection channel;
(B) moving the first mold and the second mold toward each other until the abutment surfaces of the base portion and the second mold abut against each other and until the protruding portion extends into the cavity and cooperates with the second mold to define a forming space in the cavity, the outer peripheral surface of the protruding portion being fitted into the inner peripheral surface of the mold body of the second mold;
(C) activating the injection unit for inject-ing the molten optical material into the forming space through the injection channel;
(D) cooling the molding unit to solidify the molten optical material in the forming space; and
(E) moving the first mold and the second mold away from each other after the molten optical material has solidified to expose the forming space, and subsequently activating the movable post to push the solidified optical material out of the forming space.

2. The injection molding method as claimed in claim 1, wherein in step, the moving direction is a vertical direction, and the abutment surface of the base portion and the abutment surface of the second mold extend in a horizontal direction perpendicular to the vertical direction.
